(19) United States
(12) Patent Application Publication
(10) Pub. No.: US 2025/0200145 A1
(43) Pub. Date: Jun. 19, 2025

(54) DYNAMIC METHODS FOR COMPUTING MODEL DRIFT MITIGATION

(71) Applicant: DARK MATTER TECHNOLOGIES LLC, Philadelphia, PA (US)

(72) Inventors: Timm PEDDIE, Chattanooga, TN (US); Frank POIESZ, Philadelphia, PA (US); Brian SWANSON, Lutz, FL (US); Mark WILBER, Sammamish, WA (US); Akshay JOSHI, Philadelphia, PA (US)

(21) Appl. No.: 18/545,733

(22) Filed: Dec. 19, 2023

(51) Int. Cl. G06F 18/2415; G06F 11/34

(52) U.S. Cl. CPC G06F 18/2415; G06F 11/3409

(57) ABSTRACT

Disclosed are methods, systems, and computer program products for reconfiguring a computing model that deviates from a stable operating state to an unstable operating state. The methods include: accessing a cardinality data classifier comprising a classifier computing model; configuring, based on a first data stream, the classifier computing model; determining that the classifier computing model deviates from a stable operating state to an unstable operating state when applied to a second data stream or a third data stream; determining, based on state data of the classifier computing model, configuration parameters associated with a stable operating state of the classifier computing model; and dynamically reconfiguring in real-time or near-real-time, using the configuration parameters associated with the stable operating state of the classifier model, the classifier computing model and thereby slow down or substantially eliminate the deviation of the classifier computing model from the stable operating state to the unstable operating state.

### TECHNICAL FIELD

The present disclosure relates to drift mitigation techniques for classifier computing models.

### BACKGROUND

A computing model may drift or degrade abruptly such that it would take a long time (e.g., weeks or months) to rebuild and/or stabilize said computing model. Such a model failure or drift can negatively impact the operation of other models, and/or computing systems, and/or data hierarchies and/or data architectures, and/or computing platforms associated with said computing model. There is therefore a need for timely mitigation of model drift in computing systems that leverage computing models to execute computing operations.

### SUMMARY

Disclosed are methods, systems, and computer program products for reconfiguring a computing model that deviates from a stable operating state to an unstable operating state. According to an embodiment, a method for reconfiguring a computing model that deviates from a stable operating state to an unstable operating state includes accessing a cardinality data classifier comprising: a first classifier computing model configured to assist in determining a first data class associated with a first data stream; a second classifier computing model configured to assist in determining a second data class associated with the first data stream or a second data stream; and a performance engine configured to: determine first performance data for the first classifier computing model in response to applying the first classifier computing model to the first data stream; determine second performance data for the second classifier computing model in response to applying the second classifier computing model to the first data stream or the second data stream; and determine third performance data based on the first performance data and the second performance data. The method also includes: configuring, based on the first data stream, the first classifier computing model to determine: the first performance data; the third performance data; and first state data indicating a stable operating state for the first classifier computing model. Furthermore, the method includes quantitatively or quantitatively characterizing, based on the configuring, the first performance data, the third performance data, and the first state data indicating the stable operating state for the first classifier computing model and storing within a reference library associated with the high cardinality data classifier, the qualitatively or quantitatively characterized first performance data, third performance data, and first state data in association with a first identifier associated with the first classifier computing model. Moreover, the method includes: receiving a third data stream that is similar to, or distinct from the first data stream or the second data stream; determining, based on the first identifier, that the third data stream is associated with the first classifier computing model; and generating, based on the third data stream, the first data class for the first classifier computing model, the first data class comprising one or more of: a document type associated with the third data stream; or content data associated with, or extracted from the third data stream. In addition, the method includes, determining, based on the generated first data class, the qualitatively or quantitatively characterized first performance data or third performance data, and first state data, drift event data indicating a deviation of the first classifier computing model from the stable operating state of the first classifier computing model to an unstable operating state of the first classifier computing model. Following this, the method determines, based on the first state data of the first classifier computing model, configuration parameters associated with the stable operating state of the first classifier computing model and dynamically reconfigures in real-time or near-real-time, using the configuration parameters associated with the stable operating state of the first classifier model, the first classifier computing model and thereby slows down or substantially eliminates the deviation of the first classifier computing model from the stable operating state to the unstable operating state.

In other embodiments, a system and a computer program can include or execute the method described above.

### BRIEF DESCRIPTION OF THE DRAWINGS

The disclosure is illustrated by way of example, and not by way of limitation in the figures of the accompanying drawings in which like reference numerals are used to refer to similar elements. It is emphasized that various features may not be drawn to scale and the dimensions of various features may be arbitrarily increased or reduced for clarity of discussion. Further, some components may be omitted in certain figures for clarity of discussion.

FIG. 1 shows an exemplary network system for reconfiguring a computing model that deviates from a stable operating state to an unstable operating state, in accordance with some embodiments of this disclosure.

FIG. 2 is a functional block diagram of a computing environment for reconfiguring a computing model that deviates from a stable operating state to an unstable operating state, in accordance with some embodiments of this disclosure.

FIG. 3 is a detailed system diagram of the computing environment of FIG. 2, in accordance with some embodiments of this disclosure.

FIG. 4 shows an exemplary truth table associated drift detection according to some embodiments.

FIGS. 5A and 5B provide exemplary detailed workflows for methods, systems, and computer program products for reconfiguring a computing model that deviates from a stable operating state to an unstable operating state.

### DETAILED DESCRIPTION

Reference will now be made in detail to embodiments, examples of which are illustrated in the accompanying drawings and figures. In the following detailed description, numerous specific details are set forth in order to provide a thorough understanding of the disclosed subject-matter. However, it will be apparent to one of ordinary skill in the art that the solutions disclosed may be practiced without these specific details. In other instances, well-known methods, procedures, components, circuits and networks have not been described in detail so as not to unnecessarily obscure aspects of the embodiments.

The disclosed systems and methods may be accomplished using interconnected devices and systems that obtain a plurality of data streams associated with a cardinality data classifier (e.g., high cardinality data classifier). The workflows/flowcharts described in this disclosure, according to some embodiments, implicate a new processing approach (e.g., hardware, special purpose processors, and specially programmed general-purpose processors) because such analyses are too complex and cannot be done by a person in the time available or at all. Thus, the described systems and methods are directed to tangible implementations or solutions to specific technological problems in developing optimal and stable artificial intelligence (AI) computing models that drive document or content classification.

Attention is now directed to methods, techniques, infrastructure, and workflows for operations that may be carried out using a cardinality data classifier. Some operations in the processing procedures, methods, techniques, and workflows disclosed herein may be combined while the order of some operations may be changed. Some embodiments include an iterative refinement of one or more AI models via feedback loops executed by one or more computing device processors and/or through other control devices or mechanisms that make determinations regarding whether a given action, template, or data model, or classifier computing model etc., is sufficiently accurate.

### Overview

The disclosed technology relates to dynamically adapting models (e.g., AI classifier computing models) that have drifted away from a stable operation state or mode to revert back to a stable operation state. The term model, computing model, classifier computing model are all used interchangeably herein to indicate a data construct or a data object comprising one or more data elements or parameters that are configurable and which can be used to execute operations on one or more data streams, according to some embodiments. The operations executed by the model can include: classifying operations; correlation operations; image, video, voice, or textual data extraction operations; model optimization operations; or other operations described in this disclosure.

According to one embodiment, a workflow for tagging one or more classifier computing models or profile data associated with the one or more classifier computing models is provided. In particular, each classifier computing model may have an associated accuracy score (e.g., performance data) associated with model operations including data classification operations. For example, the data classification operations may comprise document type classifications (referred to as CL document type elsewhere herein) and extracted content classifications (e.g., referred to as extraction page (EX) data elsewhere herein). According to one embodiment, the CL document type data and the EX data may have corresponding performance data associated with one or more classifier computing models.

In one embodiment, a reference library may be generated for a deployed classifier computing model such that the reference library includes performance data for the deployed classifier computing model. According to one embodiment, the reference library may comprise one or more databases that store data (e.g., state data, model identifiers, etc.) associated with the one or more classifier computing models. Specifically, the CL doc type and/or the EX data with associated performance data may have a plurality of accuracy weights or scores that are mapped to a plurality of classifier computing models based on the identifiers stored within the reference library. If a deployed classifier computing model, for example, ever drifts or degrades in performance or accuracy for any reason, an automatic trigger may be initiated to execute a failover mechanism that reverts utilization of the deployed classifier computing model based on a given CL document type and EX data at the point of drift or failure of the deployed classifier computing model.

According to one embodiment, an audit or a validation process may be executed to detect or otherwise confirm the drift or model failure. For example, the drift detection process may comprise the use of an AI drift detection mechanism associated with the cardinality data classifier that can detect model drift such that once a model drift is detected, a scan operation may be executed on the reference library associated with the classifier computing model in question or other models similar to the classifier computing model in question. In response to scanning the reference library, a specific CL document type and EX data associated with the point of failure may be applied to the model to granularly isolate specific aspects of the model requiring an update or reversion. According to one embodiment, limit data or constraint data or validation data may be applied or overlaid on the classifier computing model in response to applying the specific CL document type and EX data to the classifier computing model to qualify or otherwise quantify or identify one or more trigger (e.g., emergency triggers that initiate rerouting model prediction(s) to that of a stable version of the classifier computing model thereby dynamically updating the model. According to one embodiment, the disclosed technology includes: tracking and/or reporting mechanisms that monitor changes such as model drift; and systems that manage and/or update a drifted model back to a “new” or working model thereby refiling or updating or reconfiguring the prior classifier computing model as a fail-over. This allows a self-correcting process or workflow for failed models.

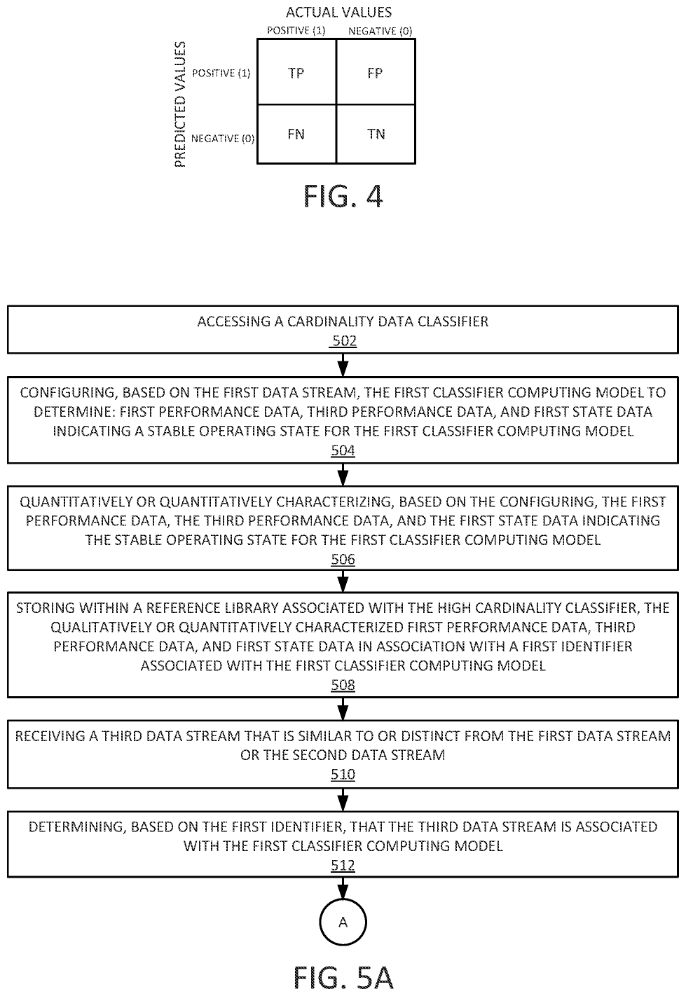

According to one embodiment, the disclosed technology enables the detection and mitigation of a model drift. For example, various reasons impacting model efficacy in document classification and content extraction processes can lead to model drift. If the mechanism(s) for providing ground truth or validation of models (e.g., classifier computing models) associated with a cardinality data classifier get compromised via malicious or accidental means, or if extraneous issues impact systems using said models for various classification operations during high or low volume periods, technical systems failure, or disaster recovery scenarios may ensure. Such scenarios need to be promptly or timely addressed in order to minimize or otherwise reduce impacts (e.g., economic, legal, or technical impacts) to downstream or upstream data workflows associated with the cardinality data classifier. Thus, the disclosed solution is directed to improving baseline stability parameters of a drifted model to protect against unforeseen circumstances or states associated with a given classifier computing model by providing multiple sets of guidelines or protective validation operations to qualify and/or quantify and/or minimize drift and/or account for negative inflection states associated with a classifier computing model. These aspects are further discussed below in association with FIGS. 4A and 4B.

### Network Environment

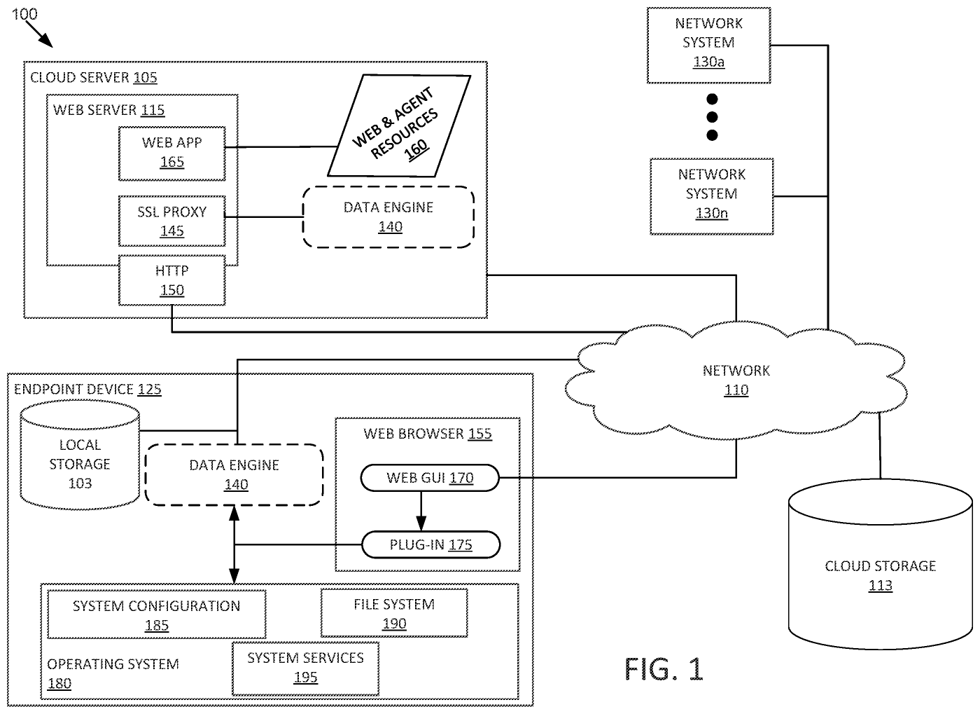

Illustrated in FIG. 1 is an exemplary network system for reconfiguring a computing model that deviates from a stable operating state to an unstable operating state. In the illustrated implementation, the system 100 may include a cloud server 105 communicatively coupled to a plurality of network systems 130a . . . 130n via a network 110. The system 100 may also include an endpoint device 125 and cloud storage 113 communicatively coupled via the network 110. While a single cloud server 105 and a single endpoint device 125 are illustrated, the disclosed principles and techniques could be expanded to include multiple cloud servers, multiple endpoints, and multiple cloud storage devices.

In some embodiments, the cloud server 105 may include a computing device such as a mainframe server, a content server, a communication server, a laptop computer, a desktop computer, a handheld computing device, a smart phone, a wearable computing device, a tablet computing device, a virtual machine, a mobile computing device, a cloud-based computing solution and/or a cloud-based service, and/or the like. The cloud server 105 may include a plurality of computing devices configured to communicate with one another and/or implement the techniques described herein.

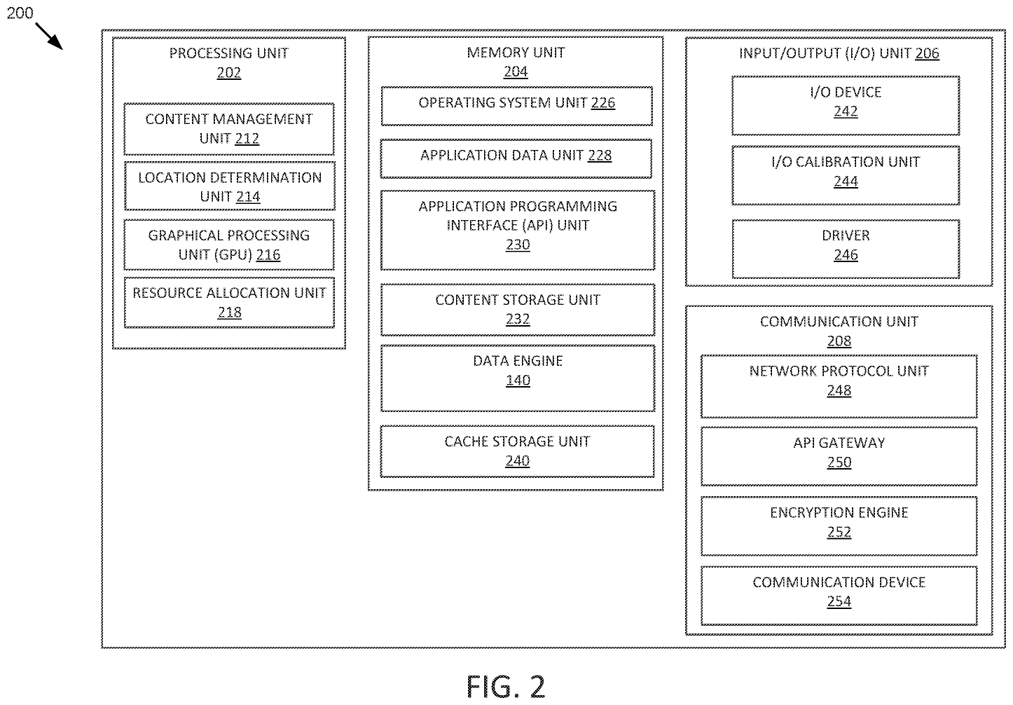

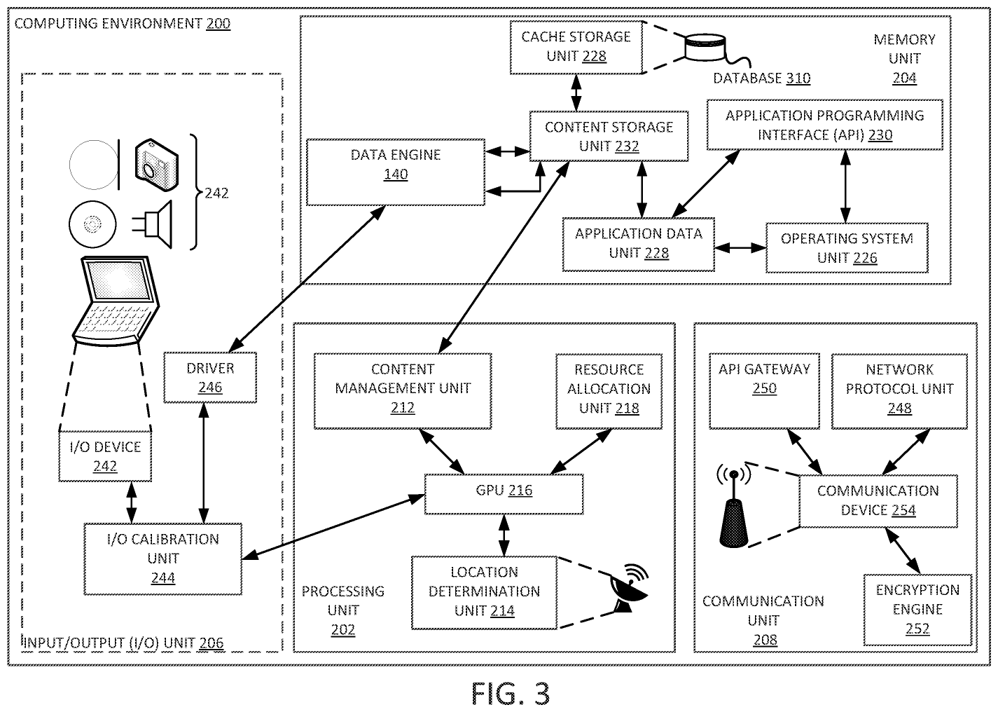

The cloud server 105 may include various elements of a computing environment as described in association with the computing environment 200 of FIGS. 2 and 3. For example, the cloud server 105 may include processing unit 202, a memory unit 204, an input/output (I/O) unit 206, and/or a communication unit 208 which are discussed in association with FIGS. 2 and 3. The cloud server 105 may further include subunits and/or other modules for performing operations associated with reconfiguring a computing model that deviates from a stable operating state to an unstable operating state. The cloud server may be locally or remotely operated as the case may require.

Turning back to FIG. 1, the cloud server 105 may include a web server 115, a data engine 140, and a web and agent resources 160. The web server 115, the data engine 140 and the web and agent resources 160 may be coupled to each other and to the network 110 via one or more signal lines. The one or more signal lines may comprise wired and/or wireless connections.

The web server 115 may include a secure socket layer (SSL) proxy 145 for establishing HTTP-based connectivity 150 between the cloud server 105 and other devices or systems coupled to the network 110. Other forms of secure connection techniques, such as encryption, may be employed on the web server 115 and across other systems coupled to the network 110. Additionally, the web server 115 may deliver artifacts (e.g., binary code, instructions, data, etc.) to the data engine 140 either directly via the SSL proxy 145 and/or via the network 110. Additionally, the web and agent resources 160 of the cloud server 105 may be provided to the endpoint device 125 via the web app 165 on the web server 115. The web and agent resources 160 may be used to render a web-based graphical interface (GUI) 170 via the browser 155 running on the endpoint device 125.

The data engine 140 may either be implemented on the cloud server 105 and/or on the endpoint device 125. The data engine 140 may include one or more instructions or computer logic that are executed by the one or more processors such as processors such as the processors discussed in association with FIGS. 2 and 3. In particular, the data engine facilitates executing the processing procedures, methods, techniques, and workflows provided in this disclosure. Some embodiments include an iterative refinement of one or more data models (e.g., learning model, large language model) associated with the system 100 disclosed via feedback loops executed by one or more computing device processors and/or through other control devices or mechanisms that make determinations regarding optimization of a given action, template, or model.

In some embodiments, the data engine 140 may access an operating system 180 of the endpoint device 125 in order to execute the disclosed techniques on the endpoint device 125. For instance, the data engine 140 may gain access into the operating system 180 including the system configuration module 185, the file system 190, and the system services module 195 in order to execute computing operations associated with reconfiguring a computing model that deviates from a stable operating state to an unstable operating state. The plug-in 175 of the web browser 155 may provide needed downloads that facilitate operations executed by the operating system 180, the data engine 140, and/or other applications running on the endpoint device 125.

The network 110 may include a plurality of networks. For instance, the network 110 may include any wired and/or wireless communication network that facilitates communication between the cloud server 105, the cloud storage 113, and the endpoint device 125. The network 110, in some instances, may include an Ethernet network, a cellular network, a computer network, the Internet, a wireless fidelity (Wi-Fi) network, a light fidelity (Li-Fi) network, a Bluetooth network, a radio frequency identification (RFID) network, a near-field communication (NFC) network, a laser-based network, a 5G network, and/or the like.

The network systems 130a . . . 130n may include one or more computing devices or servers, services, or applications the can be accessed by the cloud server 105 and/or the endpoint device 125 and or the cloud storage 113 via the network 110. In one embodiment, the network systems 130a . . . 130n comprises third-party applications or services that are native or non-native to either the cloud server 105 and/or the endpoint device 125. The third-party applications or services, for example, may facilitate executing one or more computing operations associated client specific applications.

Returning to FIG. 1, the cloud storage 113 may comprise one or more storage devices that store data, information and instructions used by the cloud server 105 and/or the endpoint device 125. The stored information may include information about users, information about data models (e.g., classifier computing models, learning model, an artificial intelligence model, etc.) associated with the cardinality data classifier. In one embodiment, the one or more storage devices mentioned above in association with the cloud storage 113 can be non-volatile memory or similar permanent storage device and media. For example, the one or more storage devices may include a hard disk drive, a CD-ROM device, a DVD-ROM device, a DVD-RAM device, a DVD-RW device, a flash memory device, solid state media, or some other mass storage device known in the art for storing information on a more permanent basis. While the cloud storage 113 is shown as being coupled to the cloud server 105 and the endpoint device 125 via the network 110, the data in the cloud storage 113 may be replicated, in some embodiments, on the cloud server 105 and/or the endpoint device 125. That is to say that a local copy of the data in the cloud storage 113 may be stored on the cloud server 105 and/or on the endpoint device 125. This local copy may be synched with the cloud storage 113 so that when there are any changes to the information in the cloud storage 113, the local copy on either the cloud server 105 or the endpoint device 125 is also similarly updated or synched in real-time or in near-real-time to be consistent with the information in the cloud storage 113 and vice versa.

Turning back to FIG. 1, the endpoint device 125 may be a handheld computing device, a smart phone, a tablet, a laptop computer, a desktop computer, a personal digital assistant (PDA), a smart device, a wearable device, a biometric device, a computer server, a virtual server, a virtual machine, a mobile device, and/or a communication server. In some embodiments, the endpoint device 125 may include a plurality of computing devices configured to communicate with one another and/or implement the techniques described in this disclosure. The data engine 140 may be used to execute operations associated with reconfiguring a computing model that deviates from a stable operating state to an unstable operating state.

The local storage 103, shown in association with the endpoint device 125, may include one or more storage devices that store data, information, and instructions used by the endpoint device 125 and/or other devices coupled to the network 110. The stored information may include various logs/records or computing event files including drift event data, security event data, etc. The one or more storage devices discussed above in association with the local database 103 can be non-volatile memory or similar permanent storage device and media. For example, the one or more storage devices may include a hard disk drive, a floppy disk drive, a CD-ROM device, a DVD-ROM device, a DVD-RAM device, a DVD-RW device, a flash memory device, solid state media, or some other mass storage device known in the art for storing information on a more permanent basis.

FIGS. 2 and 3 illustrate exemplary functional and system diagrams of a computing environment 200, according to some embodiments of this disclosure, for reconfiguring a computing model that deviates from a stable operating state to an unstable operating state. Specifically, FIG. 2 provides a functional block diagram of the computing environment 200, whereas FIG. 3 provides a detailed system diagram of the computing environment 200.

As seen in FIGS. 2 and 3, the computing environment 200 may include a processing unit 202, a memory unit 204, an I/O unit 206, and a communication unit 208. The processing unit 202, the memory unit 204, the I/O unit 206, and the communication unit 208 may include one or more subunits for performing operations described in this disclosure. Additionally, each unit and/or subunit may be operatively and/or otherwise communicatively coupled with each other and to the network 110. The computing environment 200 may be implemented on general-purpose hardware and/or specifically-purposed hardware as the case may be. Importantly, the computing environment 200 and any units and/or subunits of FIGS. 2 and/or 3 may be included in one or more elements of system 100 as described in association with FIG. 1. For example, one or more elements (e.g., units and/or subunits) of the computing environment 200 may be included in the cloud server 105 and/or the endpoint device 125 and/or the network systems 130a . . . 130n.

The processing unit 202 may control one or more of the memory unit 204, the I/O unit 206, and the communication unit 208 of the computing environment 200, as well as any included subunits, elements, components, devices, and/or functions performed by the memory unit 204, I/O unit 206, and the communication unit 208. The described sub-elements of the computing environment 200 may also be included in similar fashion in any of the other units and/or devices included in the system 100 of FIG. 1. Additionally, any actions described herein as being performed by a processor may be taken by the processing unit 202 of FIGS. 2 and 3 alone and/or by the processing unit 202 in conjunction with one or more additional processors, units, subunits, elements, components, devices, and/or the like. Further, while one processing unit 202 may be shown in FIGS. 2 and 3, multiple processing units may be present and/or otherwise included in the computing environment 200 or elsewhere in the overall system (e.g., system 100 of FIG. 1). Thus, while instructions may be described as being executed by the processing unit 202 (and/or various subunits of the processing unit 202), the instructions may be executed simultaneously, serially, and/or otherwise by one or multiple processing units 202 on one or more devices.

In some embodiments, the processing unit 202 may be implemented as one or more computer processing unit (CPU) chips and/or graphical processing unit (GPU) chips and may include a hardware device capable of executing computer instructions. The processing unit 202 may execute instructions, codes, computer programs, and/or scripts. The instructions, codes, computer programs, and/or scripts may be received from and/or stored in the memory unit 204, the I/O unit 206, the communication unit 208, subunits, and/or elements of the aforementioned units, other devices, and/or computing environments, and/or the like.

In some embodiments, the processing unit 202 may include, among other elements, subunits such as a content management unit 212, a location determination unit 214, a graphical processing unit (GPU) 216, and a resource allocation unit 218. Each of the aforementioned subunits of the processing unit 202 may be communicatively and/or otherwise operably coupled with each other.

The content management unit 212 may facilitate generation, modification, analysis, transmission, and/or presentation of content. Content may be file content, drift event content, content associated with a request data content, data stream content, media content, security event content, or any combination thereof. In some instances, content on which the content management unit 212 may operate includes device information, user interface data, image data, text data, themes, audio data or audio files, video data or video files, documents, and/or the like. Additionally, the content management unit 212 may control the audio-visual environment and/or appearance of application data during execution of various processes (e.g., via web GUI 170 at the endpoint device 125). In some embodiments, the content management unit 212 may interface with a third-party content server (e.g., third-party content server associated with the network systems 130a . . . 130n), and/or specific memory locations for execution of its operations.

The location determination unit 214 may facilitate detection, generation, modification, analysis, transmission, and/or presentation of location information. Location information may include global positioning system (GPS) coordinates, an internet protocol (IP) address, a media access control (MAC) address, geolocation information, a port number, a server number, a proxy name and/or number, device information (e.g., a serial number), an address, a zip code, and/or the like. In some embodiments, the location determination unit 214 may include various sensors, radar, and/or other specifically-purposed hardware elements for the location determination unit 214 to acquire, measure, and/or otherwise transform location information.

The GPU 216 may facilitate generation, modification, analysis, processing, transmission, and/or presentation of content described above, as well as any data described herein. In some embodiments, the GPU 216 may be used to render content for presentation on a computing device (e.g., via web GUI 170 at the endpoint device 125). The GPU 216 may also include multiple GPUs and therefore may be configured to perform and/or execute multiple processes in parallel.

The resource allocation unit 218 may facilitate the determination, monitoring, analysis, and/or allocation of computing resources throughout the computing environment 200 and/or other computing environments. For example, the computing environment may be used to process or analyze a high volume of data (e.g., a first data stream, a second data stream, and a third data stream, etc.). As such, computing resources of the computing environment 200 used by the processing unit 202, the memory unit 204, the I/O unit 206, and/or the communication unit 208 (and/or any subunit of the aforementioned units) such as processing power, data storage space, network bandwidth, and/or the like may be in high demand at various times during operation. Accordingly, the resource allocation unit 218 may include sensors and/or other specially-purposed hardware for monitoring performance of each unit and/or subunit of the computing environment 200, as well as hardware for responding to the computing resource needs of each unit and/or subunit. In some embodiments, the resource allocation unit 218 may use computing resources of a second computing environment separate and distinct from the computing environment 200 to facilitate a desired operation. For example, the resource allocation unit 218 may determine a number of simultaneous computing processes and/or requests being executed by the computing environment. The resource allocation unit 218 may also determine that the number of simultaneous computing processes and/or requests meet and/or exceed a predetermined threshold value. Based on this determination, the resource allocation unit 218 may determine an amount of additional computing resources (e.g., processing power, storage space of a particular non-transitory computer-readable memory medium, network bandwidth, and/or the like) required by the processing unit 202, the memory unit 204, the I/O unit 206, the communication unit 208, and/or any subunit of the aforementioned units for safe and efficient operation of the computing environment while supporting the number of simultaneous computing processes and/or requests. The resource allocation unit 218 may then retrieve, transmit, control, allocate, and/or otherwise distribute determined amount(s) of computing resources to each element (e.g., unit and/or subunit) of the computing environment 200 and/or another computing environment.

The memory unit 204 may be used for storing, recalling, receiving, transmitting, and/or accessing various files and/or data during operation of computing environment 200. For example, memory unit 204 may be used for storing, recalling, and/or updating exception event information as well as other data associated with, resulting from, and/or generated by any unit, or combination of units and/or subunits of the computing environment 200. In some embodiments, the memory unit 204 may store instructions, code, and/or data that may be executed by the processing unit 202. For instance, the memory unit 204 may store code that execute operations associated with one or more units and/or one or more subunits of the computing environment 200. For example, the memory unit may store code for the processing unit 202, the I/O unit 206, the communication unit 208, and for itself.

Memory unit 204 may include various types of data storage media such as solid state storage media, hard disk storage media, virtual storage media, and/or the like. Memory unit 204 may include dedicated hardware elements such as hard drives and/or servers, as well as software elements such as cloud-based storage drives. In some implementations, memory unit 204 may be a random access memory (RAM) device, a dynamic random access memory (DRAM) device, a static random access memory (SRAM) device, flash memory, read only memory (ROM) device, and/or various forms of secondary storage. The RAM device may be used to store volatile data and/or to store instructions that may be executed by the processing unit 202. For example, the instructions stored by the RAM device may be a command, a current operating state of computing environment 200, an intended operating state of computing environment 200, and/or the like. As a further example, data stored in the RAM device of memory unit 204 may include instructions related to various methods and/or functionalities described herein. The ROM device may be a non-volatile memory device that may have a smaller memory capacity than the memory capacity of a secondary storage. The ROM device may be used to store instructions and/or data that may be read during execution of computer instructions. In some embodiments, access to both the RAM device and ROM device may be faster to access than the secondary storage.

Secondary storage may comprise one or more disk drives and/or tape drives and may be used for non-volatile storage of data or as an over-flow data storage device if the RAM device is not large enough to hold all working data. Secondary storage may be used to store programs that may be loaded into the RAM device when such programs are selected for execution. In some embodiments, the memory unit 204 may include one or more databases 310 (shown in FIG. 3) for storing any data described herein. For example, depending on the implementation, the one or more databases may be used as the local storage 103 of the endpoint device discussed with reference to FIG. 1. Additionally or alternatively, one or more secondary databases (e.g., the cloud storage 113 discussed with reference to FIG. 1) located remotely from computing environment 200 may be used and/or accessed by memory unit 204. In some embodiments, memory unit 204 and/or its subunits may be local to the cloud server 105 and/or the endpoint device 125 and/or remotely located in relation to the cloud server 105 and/or the endpoint device 125.

Turning back to FIG. 2, the memory unit 204 may include subunits such as an operating system unit 226, an application data unit 228, an application programming interface (API) unit 230, a content storage unit 232, data engine 140, and a cache storage unit 240. Each of the aforementioned subunits of the memory unit 204 may be communicatively and/or otherwise operably coupled with each other and other units and/or subunits of the computing environment 200. It is also noted that the memory unit 204 may include other modules, instructions, or code that facilitate the execution of the techniques described. For instance, the memory unit 204 may include one or more modules such as a data engine 140 discussed in association with FIG. 4.

The operating system unit 226 may facilitate deployment, storage, access, execution, and/or utilization of an operating system utilized by computing environment 200 and/or any other computing environment described herein. In some embodiments, operating system unit 226 may include various hardware and/or software elements that serve as a structural framework for processing unit 202 to execute various operations described herein. Operating system unit 226 may further store various pieces of information and/or data associated with the operation of the operating system and/or computing environment 200 as a whole, such as a status of computing resources (e.g., processing power, memory availability, resource utilization, and/or the like), runtime information, modules to direct execution of operations described herein, user permissions, security credentials, and/or the like.

The application data unit 228 may facilitate deployment, storage, access, execution, and/or utilization of an application used by computing environment 200 and/or any other computing environment described herein. For example, the endpoint device 125 may be required to download, install, access, and/or otherwise use a software application (e.g., web application 165) to facilitate reconfiguring a computing model that deviates from a stable operating state to an unstable operating state. As such, the application data unit 228 may store any information and/or data associated with an application. The application data unit 228 may further store various pieces of information and/or data associated with the operation of an application and/or computing environment 200 as a whole, such as status of computing resources (e.g., processing power, memory availability, resource utilization, and/or the like), runtime information, user interfaces, modules to direct execution of operations described herein, user permissions, security credentials, and/or the like.

The API unit 230 may facilitate deployment, storage, access, execution, and/or utilization of information associated with APIs of computing environment 200 and/or any other computing environment described herein. For example, computing environment 200 may include one or more APIs for various devices, applications, units, subunits, elements, and/or other computing environments to communicate with each other and/or utilize the same data. Accordingly, API unit 230 may include API databases containing information that may be accessed and/or utilized by applications, units, subunits, elements, and/or operating systems of other devices and/or computing environments. In some embodiments, each API database may be associated with a customized physical circuit included in memory unit 204 and/or API unit 230. Additionally, each API database may be public and/or private, and so authentication credentials may be required to access information in an API database. In some embodiments, the API unit 230 may enable the cloud server 105 and the endpoint device 125 to communicate with each other. It is appreciated that the API unit 230 may facilitate accessing, using the data engine 140, one or more applications or services on the cloud server 105 and/or the network systems 130a . . . 130n.

The content storage unit 232 may facilitate deployment, storage, access, and/or utilization of information associated with performance of implementing operations associated with the network 100 and/or any other computing environment described herein. In some embodiments, content storage unit 232 may communicate with content management unit 212 to receive and/or transmit content files (e.g., media content, drift event content, data stream content, command content, input content, etc.).

As previously discussed, the data engine 140 facilitates executing the processing procedures, methods, techniques, and workflows provided in this disclosure. In particular, the data engine 140 may be configured to execute computing operations associated with the disclosed methods, systems/apparatuses, and computer program products.

The cache storage unit 240 may facilitate short-term deployment, storage, access, analysis, and/or utilization of data. In some embodiments, cache storage unit 240 may serve as a short-term storage location for data so that the data stored in cache storage unit 240 may be accessed quickly. In some instances, cache storage unit 240 may include RAM devices and/or other storage media types for quick recall of stored data. Cache storage unit 240 may include a partitioned portion of storage media included in memory unit 204.

The I/O unit 206 may include hardware and/or software elements for the computing environment 200 to receive, transmit, and/or present information useful for performing the disclosed processes. For example, elements of the I/O unit 206 may be used to receive input from a user of the endpoint device 125. As described herein, I/O unit 206 may include subunits such as an I/O device 242, an I/O calibration unit 244, and/or driver 246.

The I/O device 242 may facilitate the receipt, transmission, processing, presentation, display, input, and/or output of information as a result of executed processes described herein. In some embodiments, the I/O device 242 may include a plurality of I/O devices. In some embodiments, I/O device 242 may include a variety of elements that enable a user to interface with computing environment 200. For example, I/O device 242 may include a keyboard, a touchscreen, a button, a sensor, a biometric scanner, a laser, a microphone, a camera, and/or another element for receiving and/or collecting input from a user. Additionally and/or alternatively, I/O device 242 may include a display, a screen, a sensor, a vibration mechanism, a light emitting diode (LED), a speaker, a radio frequency identification (RFID) scanner, and/or another element for presenting and/or otherwise outputting data to a user. In some embodiments, the I/O device 242 may communicate with one or more elements of processing unit 202 and/or memory unit 204 to execute operations associated with the disclosed techniques and systems.

The I/O calibration unit 244 may facilitate the calibration of the I/O device 242. For example, I/O calibration unit 244 may detect and/or determine one or more settings of I/O device 242, and then adjust and/or modify settings so that the I/O device 242 may operate more efficiently. In some embodiments, I/O calibration unit 244 may use a driver 246 (or multiple drivers) to calibrate I/O device 242. For example, the driver 246 may include software that is to be installed by I/O calibration unit 244 so that an element of computing environment 200 (or an element of another computing environment) may recognize and/or integrate with I/O device 242 for the processes described herein.

The communication unit 208 may: facilitate establishment, maintenance, monitoring, and/or termination of communications between computing environment 200 and other computing environments, third party server systems, and/or the like (e.g., between the cloud server 105 and the endpoint device 125 and or the network systems 130a . . . 130n). Communication unit 208 may also facilitate internal communications between various elements (e.g., units and/or subunits) of computing environment 200. In some embodiments, communication unit 208 may include a network protocol unit 248, an API gateway 250, an encryption engine 252, and/or a communication device 254. Communication unit 208 may include hardware and/or other software elements.

The network protocol unit 248 may facilitate establishment, maintenance, and/or termination of a communication connection for computing environment 200 by way of a network. For example, the network protocol unit 248 may detect and/or define a communication protocol required by a particular network and/or network type. Communication protocols used by the network protocol unit 248 may include Wi-Fi protocols, Li-Fi protocols, cellular data network protocols, Bluetooth® protocols, WiMAX protocols, Ethernet protocols, powerline communication (PLC) protocols, and/or the like. In some embodiments, facilitation of communication for computing environment 200 may include transforming and/or translating data from being compatible with a first communication protocol to being compatible with a second communication protocol. In some embodiments, the network protocol unit 248 may determine and/or monitor an amount of data traffic to consequently determine which particular network protocol is to be used for establishing a secure communication connection, transmitting data, and/or performing processes described herein.

The API gateway 250 may allow other devices and/or computing environments to access the API unit 230 of the memory unit 204 associated with the computing environment 200. For example, an endpoint device 125 may access the API unit 230 of the computing environment 200 via the API gateway 250. In some embodiments, the API gateway 250 may be required to validate user credentials associated with a user of the endpoint device 125 prior to providing access to the API unit 230 to a user. The API gateway 250 may include instructions for the computing environment 200 to communicate with another computing device and/or between elements of the computing environment 200.

### Embodiments

According to some embodiments, the disclosed solution includes the following features: a model repository; a validation mechanism; workflow pipelines; configuration settings for models; one or more drift triggers; one or more performance parameters; artifact management; a failover management; a performant archive and repository for same; an updating or reconfiguring module; a tracking mechanism; a dynamic user interface; and an evaluation module. These aspects are further discussed below.

### Model Repository

The model repository of the cardinality data classifier comprises the reference library discussed above and can include one or more classifier computing model identifiers (e.g., model artifact identifiers) that facilitate tracking and/or referencing evaluation or performance operations associated with the classifier computing models based on metadata associated with one or more classifier computing models comprised in the model repository. For example, the disclosed techniques enable the use of non-mutually exclusive volume of labels or identifiers for classifier computing models together with a compounding interaction across a high cardinality of predicted data classes associated with the classifier computing models. Furthermore, the model repository including data and/or metadata associated with classifier computing model performance provides the ability to intelligently use multiple classifier computing models for resolving drift events when a given classifier computing model drifts or deviates in performance. In particular, the disclosed approach provides a novel technique that leverages model performance profile data in reliably detecting and mitigating against model drift.

### Validation Mechanism

The validation mechanism of the cardinality data classifier facilitates, according to one embodiment, execution of an accuracy validation operation that pairs, tracks, and/or references: various model evaluation data or metadata; and/or performance data or metadata associated with a given classifier computing model. For example, the validation mechanism can rely on a multi-armed bandits process. This process, according to one embodiment, enables delineating differences between simply logging or recording historical performance data for a given classifier computing model in a given knowledge space or specialty domain of the cardinality data classifier, for a given period of time relative to assessing model performance data based on just a ground truth paradigm. For example, the ground truth paradigm may indicate a level of measurement (e.g., adaptive or dynamic measurement with changeable or updatable definitions) used to define or otherwise characterize one or more objects or data associated with a classification operation. In one embodiment, the ground truth paradigm may indicate a level of measurement associated with predicting and/or validating classifying operations. In exemplary embodiments, the ground truth paradigm relates to a system of measuring, collecting, labeling, and/or identifying what data or information is true during a classifying operation. Thus, the ground truth paradigm may be considered as a structure or construct used to characterize, define, or organize information for specific use cases during a classifying operation as well as determine how said information is processed.

Furthermore, simply leveraging historical accuracy of a model (e.g., classifier computing model) may be an insufficient metric to use for validating and/or optimizing said model. As such using feedback processes that respond or adapt to model drift as well as execute counter measures against said drift provides a rapid method for drift metric assessment. According to one embodiment, the disclosed techniques leverage an automated workflow (e.g. validation workflow) for processing and/or re-processing drift data for models or sub-models comprised in the model repository so as to isolate and/or update and/or granularly optimize the model undergoing drift based on pre-processed computing operations that already have validated ground truth data (referenced above simply as ground truth). According to one embodiment, if there is an outlier in the automated workflow where there are inconclusive results associated with the drifted model, feedback data or other input data may be leveraged for the optimization of the sub-models.

### Workflow Pipelines

According to one embodiment, the disclosed techniques involve using individual processing pipelines associated with the cardinality data classifier (e.g., cardinality data classifier system) for each model family artifact as well as ancillary model groups that can execute failover access operations when drift occurs for a given model (e.g., classifier computing model). For example, the “model family” can have an associated mechanism that informs or directs how a registry associated with the reference library organizes models that are related, as a group of individual predictions that move through the pipeline collectively, as one model. Furthermore, an AI alternative trigger-based workflow in a given pipeline comprised in the individual processing pipelines can be engaged when drift is detected or when a conditional shift in the workflow dynamically reads in model artifacts from a relevant model family available to the pipeline from the registry. When drift is detected by the disclosed system, alternate versions from the model family may be isolated to qualify, characterize, or configure a model in question or a sub-model associated with the model in question with a drift flag being activated for said model. To supplement the method of predictions based on the multi-arm bandits process, a drifted class may be skipped from needing a sub-model validation workflow or other intervention. If the drifted class requires the sub-model validation workflow, an isolated process may be executed on the sub model(s) from the model family to initiate the validation workflow against the pre-processed computing operations. In one embodiment, one or more sub-model workflows may be initiated for any detected drift. The resulting sub-model, according to one embodiment, may be placed into the pipeline and moved to overlay the representative prediction in the model family, or the resulting sub-model may be added to the model family with the whole model family being updated into production. In one embodiment, identifiers and tracking processes comprised in the model repository may be used to qualify and/or quantify the historical data of each sub-model family or model family for future triaging operations.

### Configuration Settings

According to some embodiments, the disclosed system is configured to monitor the collapse (e.g., periodic collapse that indicate a drift event) of configuration settings of one or more classifier computing models on an hourly basis, a daily basis, a weekly basis, and/or a monthly basis, as appropriate, for each classifier computing model and for a given use case for said models. ‘Collapse monitoring’ as used, according to one embodiment, refers to the use of an AI computing operation that is removed from human review thereby relying purely on the AI tool driving said computing operation. For example, the disclosed approach provides a high velocity cadence of evaluation assessment operations based on a rolling lookback over a dynamic timeframe executed at a recurrent high velocity by the AI tool. This approach attempts to balance and accommodate normal fluctuations in model performance across chaotic production data workflows while simultaneously capturing variance metrics associated with drift rooted in random probability sampling of a given model's performance. To qualify when intervention is needed, a continuous performance tracking over a fixed predetermined period of computing operations may be executed using the disclosed system, and based on this continuous monitoring, collapse settings for the monitored model may be generated to bypass manual review using one or more threshold performance indicators. Using a class based random sampling of production volume and the continuous evaluations, an analysis process may be executed to determine when to intervene in the model's operation to ensure minimal impacts to the model's operation for accuracy and time to delivery constraints.

### Drift Triggers

According to one embodiment, the disclosed systems and methods include one or more triggers that activate, trigger, or provide alerts regarding a drift event associated with a given model. For example, when a model (e.g., first classifier computing model) or sub-model comprised in a model qualitatively or quantitatively drops below a particular threshold (e.g., dynamic threshold comprised in or associated with performance data of a given model), a drift trigger for the model is automatically activated. Such a trigger may be based on a deviation in accuracy of the model or sub-model, or a deviation in performance of the model or sub-model. This approach can minimize operational costs by isolating and/or pinpointing specific aspects of the model or sub-model that require optimization or reconfiguring because of the drift and thereby surgically fixing the specific aspects of the model or sub-model without altering operation of the entire model or sub-model or without affecting other aspects of the model or sub-model and/or without affecting operation of the cardinality data classifier. For example, because of the targeted model optimizations disclosed, a model or sub-model may have minimal downtimes or decrease in performance of at least 5%, or of at least 10%, or of at least 15% relative to a % 100 performance of the model or sub-model. According to one embodiment, performance data of the model or sub-model may be based on an aggregate of performance data of a plurality of model or sub-models (e.g., five epochs of performance recordings associated with a plurality of models or sub-models). This enables drift to be captured to minimize volatility in natural cycles of the model or sub-model so that drift is accounted for using consistent performance data. For example, hysteresis data associated with a model may be used to prevent rapid switching of states of the model or sub-model due to transitory fluctuations of the model. According to one embodiment, the drift triggers may be activated based on aggregate performance data of the model or sub-model over a number of evaluation cycles where the model or sub-model is consistently below 100% performance by about 5% or about 10%.

### Performance Parameters

According to one embodiment, performance data (e.g., performance parameters) associated with the model comprise an overall model performance (F1) metric, a model accuracy metric, a historical performance metric, and a stacked voting metric. According to one embodiment, the F1 metric comprises a precision value that indicates levels (e.g., medium level, low level, high level) of performance of the model while accounting for false negatives as well as generated confidence data based on true positives to account for a high percentage of total projections, predictions, or, estimations being made by the model (e.g., classifier computing model). According to one embodiment, the F1 metric is based on the truth table such as those shown in FIG. 4. In particular, the truth table of FIG. 4 shows a 2×2 prediction matrix indicating a true positive (TP) prediction instance, a false positive (FP) prediction instance, a false negative (FN) prediction instance, and a true negative (TN) prediction instance. A TP prediction instance comprises a prediction scenario where the one or more classifier computing models correctly or accurately predict information for a given class (e.g., a positive class or data that positively confirms a given data class). Similarly, a TN prediction instance comprises a prediction scenario where one or more classifier computing models correctly predict information associated with a given class (e.g., a negative class) or correctly predict data that negatively confirm a given class. On the other hand a FP prediction instance comprises a prediction scenario where one or more classifier computing models incorrectly predict information associated with a given class (e.g., the positive class referenced above) while a FN prediction instance comprises a prediction scenario where one or more classifier computing models incorrectly predict information associated with a given negative class (e.g., the negative class referenced above). According to one embodiment, the truth table of FIG. 4 beneficially enables determination of accuracy and/or precision scores or other accuracy data associated with executing classification operations using the one or more classifier computing models. The disclosed truth table may also beneficially facilitate execution of model recall operations as well as determine other performance metrics for one or more classifier computing models. Furthermore, the model accuracy metric may be based on a precision score per prediction class of the model used to qualify an accuracy of predictions being made by the model that drives the maintenance or collapse of the model.

### Artifacts Management

According to one embodiment, the disclosed technology granularizes a plurality of individual data artifacts associated with historical model failures such that the individual artifacts inform improvements or optimizations of sub-models comprised in the model (e.g., classifier computing model) associated with the reference library. While the pipeline deployment of a given model to a client system may be at a family model level that includes a plurality of predictions and expected model behavior, such an approach also enables identifying, cataloging, and storing sub-models associated with the model to facilitate the validation operations for the model. In particular, the disclosed approach supports one or more layers of granularity (e.g., at a doc level, data point level, etc.) associated with the model. According to one embodiment, performance metrics or performance data associated with the model may be computed based on various layers of granularity associated with the model. For example, the performance metrics may be based on a page level layer, a document level layer, or a complete document level layer of the model. This in effect enables model performance determinations to be made for specific aspects of the model and thereby enhance delivery of drift handling mechanisms for a drifted model.

### Failover Management

According to one embodiment, an auto-failover operation may be executed for a drifted model that protects the model from complete failure by transitioning the model to an existing or a new model. For example, once a drift event associated with a model is triggered, the following operations may be executed for said model: an automated process to validate a model recovery process is initiated to assess sub-model performance data for the given drift period; sub-models associated with the model are then received; the sub-models are integrated into a pipeline that updates the drifted mode; and a testing operation is executed on the updated model to assess its performance. In one embodiment, a drift mitigation pipeline may leverage a series of calculations to identify and/or classify both model drift for particular data classes at high drift detection velocities.

According to one embodiment, the drift mitigation pipeline uses a series of computations to identify both model drift for particular data classes at high drift detection velocities, as well as determining an anticipated impact of the drift on the workload volume falling out of automation based on the determined drift trigger. Furthermore, the automation process may leverage either an event-driven or batch-directed process for class focus modelling through a multi-armed bandits process, to generate a production system comprising an encoded array of distinct models from the model registry. When evaluation results show an apparent failure to meet AI performance guidelines (e.g., a service-level agreement (SLA) collapse criteria), an automated workflow is executed across previously deployed sub-model artifacts in the context of the prediction seeing drift. This can then be leveraged across models to improve AI validation of the sub model. Moreover, multi-armed bandits processes can be used to provide optimal determinations of which artifacts associated with performant or non-performant models or sub-models should be brought in for testing relative to a standard mix of exploration and exploitation computing operations that impact the cardinality data classifier.

In one embodiment, highly performant models may most likely be selected for sub-model validation operations while less performant artifacts can still be explored with lower frequency, for example, in cases where the low performance of the less performant artifacts was due to randomized errors/issues. Since historic performance for artifacts may poorly represent how models work under a changed distribution of data, there may be different ways to manage the bandits' internal parameters, which in turn determine how the AI engine powering the various classifier computing models dynamically leverages different artifacts. For example, when a drift event triggers deployment of comparison artifacts via, for example, the validation workflow, corresponding bandits may be initialized, based on the bandits process, with weak priors using historic performance of the model, which would allow for learning new performance attributes relatively quickly.

The tiered execution of sub-models provides methodological opportunities to stack an ensemble of predicted model values and confidence scores to create an agreeance framework for mitigating drift mis-predictions. One or more of these sub-models can then be moved into a pre-production automation workflow to validate recent performance data against post-production ground truth. The drift mitigation pipeline may also be triggered if it is determined that there is data queue flooding due to drift, with an artifact kicking out of a level seeing AI automation and which falls back to a review process. This may see an influx of a data stream (e.g., documents, files, etc.) requiring further processing. In such a scenario, the model registry and the evaluation data (e.g., eval data) may be used to select a predetermined number of one or more models and deploy said models to an alternative workflow till either a new model is trained to account for drift or the drift gets corrected on its own. The current production model may be used to “compete” via a bandits process with historic models, since there is no basis for expecting historic artifacts to perform better in the event of data distribution shifts. Unlike other solutions that rely on more humans for validating a failover, the disclosed approach goes to the post-production ground truth workflow for automating AI model performance. Other validation operations may be applied to high-volume classes falling out of a collapse threshold. In the validation workflow, an ensemble of models and model agreeance between models may be used to qualify the sub-model performance and reliability. When enabling these drift mitigation techniques, classes may be prioritized based on impacts by volume to the service-level agreement's and contractual obligations for performance to minimize the overall impact to the cardinality data classifier.

### Archive of Performant Models

The disclosed approach includes a system for tagging, tracking, and/or updating model characteristics and information to facilitate cataloging and clearing older, less-performant models and sub-models. In particular, the disclosed technology leverages a machine learning operations (ML Ops) system or an AI operations system to store and/or track information from both systems training one or more classifier computing models and systems producing outputs based on trained classifier computing models from periods of model creation to deployment. Furthermore, the disclosed techniques assess model performance during evaluation periods and further monitor data sources used to train and configure the classifier computing models. This beneficially enables the tagging and storage of drift events which can serve as basis for determining models and sub-models used for drift mitigation. Leveraging a system of retention rules that are, for example, associated with the most performant models may be saved to help manage operational strategies for mitigating against drift.

### Repository of Prior, Stored, Artifact Performance

In some embodiments, the disclosed approach includes mechanisms for generating identifiers (e.g., reference identifiers (ref. IDs)) or a model registry including a system for representing and/or storing attributes associated with model performance. The model registry can act as a data storage system with unique model numbers and descriptive metadata about the creation of a classifier computing model and/or sub-models associated with same with details which link to other data from both training and production systems based on dates/periods of model creation and deployment, performance evaluation data, and source data associated with the training data. The performance metadata in the repository or reference library may form a part of an alternate workflow to be used in a drift mitigation workflow.

System for Updating Changes into an Existing New Model

The disclosed systems also allow for the copy or overlay of a performant sub-model onto non-performant or drift triggering sub-models of a deployed classifier computing model. The pipeline that initiates this process may be used to update or otherwise optimize a drifted model based on model identifier data without needing to do a full model or application update (“Hot-swappable”).

### Historical Operator Level Accuracy Performance Tracking at Granular Level

According to some embodiments, the disclosed techniques facilitate the reporting of associated sub-models and changes to classifier computing models to stakeholders. For example, the reporting mechanism may be incorporated in a workflow optimization to automatically assign operators to drift detection and mitigation processes for better support production volume with minimum impacts to a given SLA. Moreover, the tools disclosed also facilitate performance tracking and assignment of models for failover model selection and stacking. For example, the tools disclosed can show or provide a history of changes for each sub-model and its parent model, dates, times, client, or other legacy information. To better use a performant model for drift mitigation scenarios, having this legacy information readily available helps in determining which models to use to support drift mitigation strategies.

### UI Capabilities

The disclosed approach includes an operator “queue-less” user interface (UI) or an “environment-less” UI capability for seamless operator failover queue experience. In one embodiment, a prioritization of drift where some actions can happen automatically while others may be a flag for consideration may be displayable in the UI. For example, the base workflow for post-production processing of the one or more sub-models may be fully automated to validate against transactions that already received ‘pristine’ ground truth by review processes. As such additional review processes may not be needed, according to some embodiments, in a majority of use cases with reviews being used when results are inconclusive or a drift outlier event is flagged.

### Evaluation Features

The disclosed system also includes mechanisms that execute “re-collapse” evaluation and decision checkpoint operations for pulling production volume data back out of a production queue (e.g., a Prod queue) once “real-time” validation of failover state is achieved and also execute reassigning operations to update models. The validation system may be activated once the sub-model moves in to ‘replace’ the old sub-model (e.g., old sub-model of a drifted model) for an operational data point (e.g., document data point, or similar model states) associated with the cardinality data classifier. In one embodiment, the continuous model evaluations may be supplemented with a dedicated drift mitigation evaluation process to turn off the drift mitigation workflow when the model performance reaches the AI automation thresholds. When the sub-model returns to a qualified performance level after the mitigation moves to production, the full AI automation is reactivated for the model.

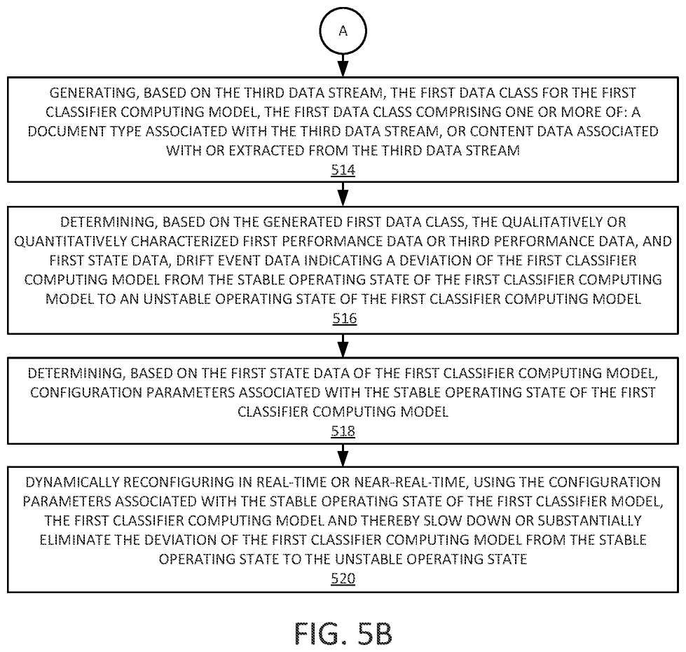

FIGS. 5A and 5B provide exemplary detailed workflows for methods, systems, and computer program products for reconfiguring a computing model that deviates from a stable operating state to an unstable operating state. It is appreciated that a data engine (e.g., data managing module) stored in a memory device may cause a computer processor to execute the various processing stages of the workflow shown. For example, the disclosed techniques may be implemented as a data engine or a signal processing engine within a data management or data classification software tool such that the data engine or signal processing engine enables the reconfiguring of one or more computing models (e.g., classifier computing models) that have deviated from a stable operating state to an unstable operating state.

At block 502, the data engine may access a cardinality data classifier comprising: a first classifier computing model configured to assist in determining a first data class associated with a first data stream; a second classifier computing model configured to assist in determining a second data class associated with the first data stream or a second data stream; and a performance engine. In one embodiment, the performance engine is configured to: determine first performance data for the first classifier computing model in response to applying the first classifier computing model to the first data stream; determine second performance data for the second classifier computing model in response to applying the second classifier computing model to the first data stream or the second data stream; and determine third performance data based on the first performance data and the second performance data. It is appreciated that applying the first classifier computing model to the first data stream can comprise: categorizing or classifying, using the first classifier computing model, specific data comprised in the first data stream; and/or extracting, using the first classifier computing model, specific content data comprised in the first data stream; and/or combining or operating on specific data comprised in the first data stream using the first classifier computing model. The second classifier computing model may be similarly used to categorize and/or extract data and/or operate on data elements associated with the first data stream or the second data stream. It is appreciated that the third performance data referenced in association with the performance engine of the cardinality data classifier may be generated based on a combination of the first performance data and the second performance data and/or based on some other cumulative and/or aggregate relationship between the first performance data and the second performance data discussed above.

Turning to block 504, the data engine may configure, based on the first data stream, the first classifier computing model to determine one or more of: the first performance data; the third performance data; and first state data indicating a stable operating state for the first classifier computing model. It is appreciated that the configuring operation associated with block 504 comprises training the first classifier computing model using data elements of the first data stream to generate the first performance data, the third performance data, and the first state data. It is further appreciated that generation of the third performance data at this stage is based on designating or determining a contribution of the performance information associated with training the first classifier computing model to the overall performance of the cardinality data classifier.

At block 506, the data engine may quantitatively or quantitatively characterize, based on configuring or training the first classifier computing model: the first performance data; the third performance data; and the first state data indicating the stable operating state for the first classifier computing model. In one embodiment, quantitatively characterizing the first performance data, the third performance data, and the first state data indicating the stable operating state for the first classifier computing model may comprise ascribing or assigning numerical weights or numerical values to the first performance data, the third performance data, and/or the first state data in response to configuring or training the first classifier computing model. In other embodiments, qualitatively characterizing the first performance data, the third performance data, and the first state data may comprise tagging or labeling the first performance data, the third performance data, and/or the first state data qualitative values (e.g., low, medium, high) or some other adjectival values indicating a degree of intensity or severity associated with the first performance data, the third performance data, and/or the first state data.

Following the characterizing operation, the qualitatively or quantitatively characterized first performance data, third performance data, and first state data in association with a first identifier associated with the first classifier computing model may be stored within a reference library associated with the cardinality data classifier at block 508. The first identifier, for example, may comprise an identifier within the reference library that can be used to uniquely identify or locate the first classifier computing model.

At block 510, the data engine may receive a third data stream that is similar to or distinct from the first data stream or the second data stream. In exemplary implementations, the third data stream comprises new data that was not used to originally train or configure either the first classifier computing model and/or the second classifier computing model.

Based on the first identifier, the data engine may further determine, at block 512, that the third data stream is associated with the first classifier computing model. The data engine may then generate, at block 514, based on the third data stream, the first data class for the first classifier computing model. The first data class, for example, may comprise one or more of: a document type associated with the third data stream; and/or content data associated with or extracted from the third data stream.

The data engine may further determine, at block 516, based on one or more of the generated first data class, the qualitatively or quantitatively characterized first performance data or third performance data, and first state data, drift event data indicating a deviation of the first classifier computing model from the stable operating state of the first classifier computing model to an unstable operating state of the first classifier computing model. In addition, the data engine may further determine, at block 518, based on the first state data of the first classifier computing model, configuration parameters associated with the stable operating state of the first classifier computing model. Following this the data engine may dynamically reconfigure, at block 520, in real-time or near-real-time, using the configuration parameters associated with the stable operating state of the first classifier model, the first classifier computing model and thereby slow down or substantially eliminate the deviation of the first classifier computing model from the stable operating state to the unstable operating state.

These and other implementations may each optionally include one or more of the following features. The cardinality data classifier may be a high cardinality data classifier comprising two or more artificial intelligence (AI) classifier computing models including the first classifier computing model and the second classifier computing model. The two or more AI classifier computing models may be configured to predict a plurality of data classes including the first data class and the second data class. Moreover, the plurality of data classes may include one or more of: a plurality of document types, and a plurality of content data comprised in a plurality of data streams including the first data stream, the second data stream, or the third data stream. In one embodiment, the two or more AI classifier computing models are performant classifier computing models whose performance data is used by an AI engine, in real-time, to drive reconfiguring of the first classifier computing model in response to detecting model drift based on the drift event data as further discussed below.

It is appreciated that the high cardinality data classifier can comprise a plurality of AI classifier computing models that are streamed, monitored, or otherwise regulated by an AI engine associated with the high cardinality data classifier. For example, the AI engine may monitor, in real-time or near-real-time, performance data associated with two or more classifier computing models to establish a performance framework or dynamic or updatable standard which may be applied to correct or reconfigure a drifting classifier computing model. That is to say that the AI engine is adapted to dynamically identify, aggregate, or otherwise separate performant models from non-performant models, on-the-fly, such that at any point in time, the AI engine has a toolbox of performant models that optimally facilitate accurate execution of classifying operations based on any received data stream. Thus, when a given classifier computing model is drifting, the AI engine is able to isolate the drifting classifier computing model as well as leverage configuration data from previously aggregated performant models to update or otherwise reconfigure the drifting classifier computing model. In some cases, the AI engine is able to granularize the configuration parameters associated with a plurality of performant classifier computing models such that the AI engine surgically extracts relevant aspects or parameters comprised in the configuration parameters associated with the plurality of performant classifier computing models to correct or update or reconfigure a drifting classifier computing model. It is worth mentioning that the AI engine is able to keep or maintain one or more pools of performant classifier computing models based on a multi-armed bandits process and/or a naive Bayesian process that establishes agreeance between a given pool or set of performant models that accurately execute classifying operations for specific data streams. Thus, the disclosed approach, in some embodiments, eliminates human intervention (with associated costs in human errors) in model drift mitigation at any time during the classification process of a given classifier computing model by leveraging the AI engine to correct model drift based on aggregated performant models.

In exemplary implementations, one or more classifier computing models may drift (e.g., as indicated by drift event data) because of anomalies in a received data stream (e.g., first data stream, second data stream, or third data stream, etc.) and/or misconfigurations of the one or more classifier computing models and/or changes to the types of data comprised in a received data stream. The above-referenced anomalies may be human generated or non-human generated according to some embodiments. To detect drift, performance data associated with the one or more classifier computing models may be leveraged to flag a drift event. The performance data may include, for example, an F1 metric or some other precision score that characterizes the performance of a classifier computing model. In one embodiment, the F1 metric measures the ability of a given classifier computing model to accurately execute a classifying operation. In particular, the F1 metric enables designating performance data of a given classifier computing model into one of the categories or prediction instances of the prediction matrix outlined in FIG. 4. It is further appreciated that the F1 metric includes precision data associated with a given classifier computing model that indicates the fraction of accurate true positive (TP) classifications of a given classifier computing model.

In some embodiments, the cardinality data classifier may be configured to: classify, based on classifier computing models comprised in the cardinality data classifier, content data comprised in the first data stream, the second data stream, or the third data stream; and determine, based on the classifier computing models comprised in the cardinality data classifier, a document type associated with or comprised in the first data stream, the second data stream, or the third data stream.

In exemplary embodiments, the first data class or the second data class comprises logic configured to execute at least one computing operation based on the first data stream, the second data stream, or the third data stream. For example, the logic may include computing operations that electronically: combine data elements associated with the first data stream, the second data stream, or the third data stream; filter data elements associated with the first data stream, the second data stream, or the third data stream; correlate data elements associated with the first data stream, the second data stream, or the third data stream; quantitatively or qualitatively label or classify one or more data elements associated with the first data stream, the second data stream, or the third data stream; extract specific image or textual data associated with the first data stream, the second data stream, or the third data stream; etc. In exemplary implementations, the various computing operations executed on the data elements associated with the first data stream, the second data stream, or the third data stream results in generation of a file, a document, or a report indicating, for example: evidence of completion of a first electronic computing operation associated with a scanned image, video, or textual data; a record of data relationships between one or more data elements associated with the first data stream, the second data stream, or the third data stream; receipt data associated with a second electronic computing operation associated with scanned image, video, or textual data, etc. It is appreciated that the generated file, report, or document may facilitate auditing operations associated with the first or second electronic computing operations and/or the record of data relationships referenced above. In exemplary scenarios, the generated file, document, or report beneficially find utility or use in data systems including research data systems, educational data systems, financial data systems, government data systems, etc., that classify or categorize data for a plurality of uses.

Moreover, the performance engine discussed in association with the cardinality data classifier can be configured to determine performance relationship data indicating a performance strength of the first classifier computing model relative to a performance strength of the second classifier computing model based on one or more of the first data stream or the second data stream. In addition, the performance relationship data can enable selection of one of the first classifier computing model or the second classifier computing model based on the first data stream or the second data stream. Furthermore, the performance engine of the cardinality data classifier may be configured to determine cumulative performance data of the cardinality data classifier based on averaging of performance data of a plurality of classifier computing models comprised in the cardinality data classifier. This cumulative performance data may inform the overall performance of the cardinality data classifier and thereby drive optimization operations for aspects of the cardinality data classifier that may be underperforming.

In some embodiments, the reference library discussed above may comprise or store a plurality of configuration parameters and a plurality of identifiers associated with a plurality of stable operating states of a plurality of classifier computing models including the first classifier computing model and the second classifier computing model.

It is appreciated that the drift event data includes a drift velocity parameter associated with the first classifier computing model. The drift velocity parameter may indicate a rate of the deviation of the first classifier computing model from the stable operating state to the unstable operating state. This rate of deviation can inform stakeholders of how fast the classifier computing model is deviating and can serve as a guide in implementing drift mitigation strategies such as those discussed above.

In some cases, the configuration parameters associated with the stable operating state of the first classifier computing model comprise granular attribute data associated with the first classifier computing model. The granular attribute data associated with the first classifier computing model may be applied to the first classifier computing model without disrupting operation of one or more of the first classifier computing model or the high cardinality data classifier.

Furthermore, the cardinality data classifier may be configured to simultaneously determine a plurality of data classes for a plurality of input data streams using a plurality of classifier computing models including the first classifier computing model and the second classifier computing model. In particular, the cardinality data classifier may be configured to determine, based on a plurality of data streams, a plurality of data classes which in aggregate, comprise a first amount or a first number. In addition, the cardinality data classifier may determine the plurality of data classes referenced above using a plurality of computing models, which (e.g., the plurality of data classes) in aggregate, comprise a second amount or a second number. It is appreciated that the first amount of the plurality of data classes is quantitatively more in number relative to the second amount of the plurality of computing models.

It is appreciated that the first data stream, or the second data stream, or the third data stream may comprise report data, and/or document data, and/or file data including one or more of image data, textual data, and/or video data. In some cases, the report data, the document data, or the file data may be associated with a research institution, an educational institution, a medical institution, a financial institution, a government institution, or a private institution, or some other institution executing a data classification operation as described herein.

In the preceding description, for purposes of explanation, numerous specific details are set forth in order to provide a thorough understanding of the disclosure. It will be apparent, however, that the disclosure can be practiced without these specific details. In other instances, structures and devices have been shown in block diagram form in order to avoid obscuring the disclosure. For example, the present disclosure has been described in some implementations above with reference to interfaces and particular hardware. However, the present disclosure applies to any type of computing device that can receive data and commands, and any devices providing data services.

Reference in the specification to “one implementation” or “an implementation” or “one embodiment” or “some embodiments” means that a particular feature, structure, or characteristic described in connection with the implementation/embodiment is included in at least one implementation of the disclosure. The appearances of the phrase “in one implementation/embodiment” or “in some implementations/embodiments” in various places in the specification are not necessarily all referring to the same implementation/embodiment. It is appreciated that the term optimize/optimal and its variants (e.g., efficient or optimally) may simply indicate improving, rather than the ultimate form of ‘perfection’ or the like.

Some portions of the detailed descriptions above are presented in terms of algorithms, modules, and symbolic representations of operations on data bits within a computer memory. These descriptions and representations are the means used by those skilled in data processing arts to most effectively convey the substance of their work to others skilled in the art.

The present disclosure also relates to an apparatus for performing the operations disclosed. This apparatus may be specially constructed for the required purposes, or it may include a general-purpose computer selectively activated or reconfigured by a computer program stored in the computer. Such a computer program may be stored in a computer readable storage medium, for example, any type of disk including floppy disks, optical disks, CD-ROMs, and magnetic disks, read-only memories (ROMs), random access memories (RAMs), EPROMS, EEPROMs, magnetic or optical cards, flash memories including USB keys with non-volatile memory or any type of media suitable for storing electronic instructions, each coupled to a computer system bus.

The disclosure can take the form of an entirely hardware implementation, an entirely software implementation or an implementation containing both hardware and software elements. In some implementations, the disclosure is implemented in software, which includes but is not limited to firmware, resident software, microcode, etc.

Furthermore, the disclosure can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

Finally, the foregoing description of the implementations of the present disclosure has been presented for the purposes of illustration and description. It is not intended to be exhaustive or to limit the present disclosure to the precise form disclosed. Many modifications and variations are possible in light of the above teaching. It is intended that the scope of the present disclosure be limited not by this detailed description, but rather by the claims of this application. As will be understood by those familiar with the art, the present disclosure may be embodied in other specific forms without departing from the spirit or essential characteristics thereof. Likewise, the particular naming and division of the modules, routines, features, attributes, methodologies and other aspects are not mandatory or significant, and the mechanisms that implement the present disclosure or its features may have different names, divisions and/or formats. Furthermore, the relevant art, the modules, routines, features, attributes, methodologies and other aspects of the present disclosure can be implemented as software, hardware, firmware or any combination of the three. Also, wherever a component, an example of which is a module, of the present disclosure is implemented as software, the component can be implemented as a standalone program, as part of a larger program, as a plurality of separate programs, as a statically or dynamically linked library, as a kernel loadable module, as a device driver, and/or in every and any other way known now or in the future in the art of computer programming. Additionally, the present disclosure is in no way limited to implementation in any specific programming language, or for any specific operating system or environment. Accordingly, the disclosure of the present disclosure is intended to be illustrative, but not limiting, of the scope of the present disclosure, which is set forth in the following claims.

What is claimed is:

1. A method for reconfiguring a computing model that deviates from a stable operating state to an unstable operating state, the method comprising:
accessing, using one or more computing device processors, a cardinality data classifier comprising:
a first classifier computing model configured to assist in determining a first data class associated with a first data stream;
a second classifier computing model configured to assist in determining a second data class associated with the first data stream or a second data stream;
a performance engine configured to:
determine first performance data for the first classifier computing model in response to applying the first classifier computing model to the first data stream, and
determine second performance data for the second classifier computing model in response to applying the second classifier computing model to the first data stream or the second data stream,
determine third performance data based on the first performance data and the second performance data;
configuring, using the one or more computing device processors and based on the first data stream, the first classifier computing model to determine:
the first performance data,
the third performance data, and
first state data indicating a stable operating state for the first classifier computing model;
quantitatively or quantitatively characterizing, using the one or more computing device processors and based on the configuring, the first performance data, the third performance data, and the first state data indicating the stable operating state for the first classifier computing model;
storing within a reference library associated with the high cardinality data classifier, using the one or more computing device processors, the qualitatively or quantitatively characterized first performance data, third performance data, and first state data in association with a first identifier associated with the first classifier computing model;
receiving, using the one or more computing device processors, a third data stream that is similar to or distinct from the first data stream or the second data stream;
determining, using the one or more computing device processors and based on the first identifier, that the third data stream is associated with the first classifier computing model;
generating, using the one or more computing device processors and based on the third data stream, the first data class for the first classifier computing model, the first data class comprising one or more of:
a document type associated with the third data stream, or
content data associated with or extracted from the third data stream;
determining, using the one or more computing device processors and based on the generated first data class, the qualitatively or quantitatively characterized first performance data or third performance data, and first state data, drift event data indicating a deviation of the first classifier computing model from the stable operating state of the first classifier computing model to an unstable operating state of the first classifier computing model;
determining, using the one or more computing device processors and based on the first state data of the first classifier computing model, configuration parameters associated with the stable operating state of the first classifier computing model; and
dynamically reconfiguring in real-time or near-real-time, using the one or more computing device processors and the configuration parameters associated with the stable operating state of the first classifier model, the first classifier computing model and thereby slow down or substantially eliminate the deviation of the first classifier computing model from the stable operating state to the unstable operating state.

2. The method of claim 1, wherein:
the cardinality data classifier is a high cardinality data classifier comprising two or more artificial intelligence (AI) classifier computing models including the first classifier computing model and the second classifier computing model;
the two or more AI classifier computing models being configured to predict a plurality of data classes including the first data class and the second data class; and
the plurality of data classes including one or more of:
a plurality of document types, and
a plurality of content data comprised in a plurality of data streams including the first data stream, the second data stream, or the third data stream, and
the two or more AI classifier computing models are performant classifier computing models whose performance data is used by an AI engine, in real-time, to drive reconfiguring of the first classifier computing model in response to detecting model drift based on the drift event data.

3. The method of claim 1, wherein the cardinality data classifier is configured to:
classify, based on classifier computing models comprised in the cardinality data classifier, content data comprised in the first data stream, the second data stream, or the third data stream; and
determine, based on the classifier computing models comprised in the cardinality data classifier, a document type associated with or comprised in the first data stream, the second data stream, or the third data stream.

4. The method of claim 1, wherein the first data class or the second data class comprises logic configured to execute at least one computing operation based on the first data stream, the second data stream, or the third data stream.

5. The method of claim 1, wherein the performance engine of the cardinality data classifier is configured to determine performance relationship data indicating a performance strength of the first classifier computing model relative to a performance strength of the second classifier computing model based on one or more of the first data stream or the second data stream.

6. The method of claim 5, wherein the performance relationship data enables selection of one of the first classifier computing model or the second classifier computing model based on the first data stream or the second data stream.

7. The method of claim 1, wherein the performance engine of the cardinality data classifier is configured to determine cumulative performance data of the cardinality data classifier based on averaging of performance data of a plurality of classifier computing models comprised in the cardinality data classifier.

8. The method of claim 1, wherein the reference library comprises a plurality of configuration parameters and a plurality of identifiers associated with a plurality of stable operating states of a plurality of classifier computing models including the first classifier computing model and the second classifier computing model.

9. The method of claim 1, wherein the drift event data includes a drift velocity parameter associated with the first classifier computing model, the drift velocity parameter indicating a rate of the deviation of the first classifier computing model from the stable operating state to the unstable operating state.

10. The method of claim 1, wherein:
the configuration parameters associated with the stable operating state of the first classifier computing model comprise granular attribute data associated with the first classifier computing model; and
the granular attribute data associated with the first classifier computing model is applied to the first classifier computing model without disrupting operation of one or more of the first classifier computing model or the high cardinality data classifier.

11. The method of claim 1, wherein the cardinality data classifier is configured to simultaneously determine a plurality of data classes for a plurality of input data streams using a plurality of classifier computing models including the first classifier computing model and the second classifier computing model.

12. The method of claim 1, wherein:
the cardinality data classifier is configured to determine, based on a plurality of data streams, a plurality of data classes which in aggregate, comprise a first amount;
the cardinality data classifier determines the plurality of data classes using a plurality of computing models, which in aggregate, comprise a second amount; and
the first amount of the plurality of data classes is quantitatively more in number relative to the second amount of the plurality of computing models.

13. A system for reconfiguring a computing model that deviates from a stable operating state to an unstable operating state, the system comprising:
one or more computing system processors; and
memory storing instructions that, when executed by the one or more computing system processors, causes the system to:
access a cardinality data classifier comprising:
a first classifier computing model configured to assist in determining a first data class associated with a first data stream;
a second classifier computing model configured to assist in determining a second data class associated with the first data stream or a second data stream;
a performance engine configured to:
determine first performance data for the first classifier computing model in response to applying the first classifier computing model to the first data stream, and
determine second performance data for the second classifier computing model in response to applying the second classifier computing model to the first data stream or the second data stream,
determine third performance data based on the first performance data and the second performance data;
configure, based on the first data stream, the first classifier computing model to determine:
the first performance data,
the third performance data, and
first state data indicating a stable operating state for the first classifier computing model;
quantitatively or quantitatively characterize, based on the configuring, the first performance data, the third performance data, and the first state data indicating the stable operating state for the first classifier computing model;
store within a reference library associated with the high cardinality data classifier, the qualitatively or quantitatively characterized first performance data, third performance data, and first state data in association with a first identifier associated with the first classifier computing model;
receive a third data stream that is similar to or distinct from the first data stream or the second data stream;
determine, based on the first identifier, that the third data stream is associated with the first classifier computing model;
generate, based on the third data stream, the first data class for the first classifier computing model, the first data class comprising one or more of:
a document type associated with the third data stream, or
content data associated with or extracted from the third data stream;
determine, based on the generated first data class, the qualitatively or quantitatively characterized first performance data or third performance data, and first state data, drift event data indicating a deviation of the first classifier computing model from the stable operating state of the first classifier computing model to an unstable operating state of the first classifier computing model;
determine, based on the first state data of the first classifier computing model, configuration parameters associated with the stable operating state of the first classifier computing model; and
dynamically reconfigure in real-time or near-real-time, using the configuration parameters associated with the stable operating state of the first classifier computing model, the first classifier computing model and thereby slow down or substantially eliminate the deviation of the first classifier computing model from the stable operating state to the unstable operating state.

14. The system of claim 13, wherein:
the cardinality data classifier is a high cardinality data classifier comprising two or more artificial intelligence (AI) classifier computing models including the first classifier computing model and the second classifier computing model;
the two or more AI classifier computing models being configured to predict a plurality of data classes including the first data class and the second data class; and
the plurality of data classes including one or more of:
a plurality of document types, and
a plurality of content data comprised in a plurality of data streams including the first data stream, the second data stream, or the third data stream, and
the two or more AI classifier computing models are performant classifier computing models whose performance data is used by an AI engine, in real-time, to drive reconfiguring of the first classifier computing model in response to detecting model drift based on the drift event data.

15. The system of claim 13, wherein the cardinality data classifier is configured to:
classify, based on classifier computing models comprised in the cardinality data classifier, content data comprised in the first data stream, the second data stream, or the third data stream; and
determine, based on the classifier computing models comprised in the cardinality data classifier, a document type associated with or comprised in the first data stream, the second data stream, or the third data stream.

16. The system of claim 13, wherein the first data class or the second data class comprises logic configured to execute at least one computing operation based on the first data stream, the second data stream, or the third data stream.

17. The system of claim 13, wherein the reference library comprises a plurality of configuration parameters and a plurality of identifiers associated with a plurality of stable operating states of a plurality of classifier computing models including the first classifier computing model and the second classifier computing model.

18. The system of claim 13, wherein:
the cardinality data classifier is configured to determine, based on a plurality of data streams, a plurality of data classes which in aggregate, comprise a first amount;
the cardinality data classifier determines the plurality of data classes using a plurality of computing models, which in aggregate, comprise a second amount; and
the first amount of the plurality of data classes is quantitatively more in number relative to the second amount of the plurality of computing models.

19. A method for reconfiguring a computing model that deviates from a stable operating state to an unstable operating state, the method comprising:
receiving, using one or more computing device processors, a first data stream associated with a cardinality data classifier;
accessing, using one or more computing device processors, the cardinality data classifier;
configuring, using the one or more computing device processors and based on the first data stream, a first classifier computing model of the cardinality data classifier to determine:
first performance data associated with the first classifier computing model,
third performance data associated with the cardinality data classifier, and
first state data indicating a stable operating state for the first classifier computing model;
quantitatively or quantitatively characterizing, using the one or more computing device processors and based on the configuring, the first performance data, the third performance data, and the first state data indicating the stable operating state for the first classifier computing model;
storing within a reference library associated with the high cardinality data classifier, using the one or more computing device processors, the qualitatively or quantitatively characterized first performance data, third performance data, and first state data in association with a first identifier associated with the first classifier computing model;
receiving, using the one or more computing device processors, a third data stream that is similar to or distinct from the first data stream or a second data stream associated with the cardinality data classifier;
determining, using the one or more computing device processors and based on the first identifier, that the third data stream is associated with the first classifier computing model;
generating, using the one or more computing device processors and based on the third data stream, a first data class for the first classifier computing model, the first data class comprising one or more of:
a document type associated with the third data stream, or
content data associated with or extracted from the third data stream;
determining, using the one or more computing device processors and based on the generated first data class, the qualitatively or quantitatively characterized first performance data or third performance data, and first state data, drift event data indicating a deviation of the first classifier computing model from the stable operating state of the first classifier computing model to an unstable operating state of the first classifier computing model;
determining, using the one or more computing device processors and based on the first state data of the first classifier computing model, configuration parameters associated with the stable operating state of the first classifier computing model; and
dynamically reconfiguring in real-time or near-real-time, using the one or more computing device processors and the configuration parameters associated with the stable operating state of the first classifier computing model, the first classifier computing model and thereby slow down or substantially eliminate the deviation of the first classifier computing model from the stable operating state to the unstable operating state.

20. The method of claim 19, wherein the cardinality data classifier comprises:
the first classifier computing model configured to assist in determining the first data class associated with a first data stream;
a second classifier computing model configured to assist in determining a second data class associated with the first data stream or the second data stream;
a performance engine configured to:
determine the first performance data for the first classifier computing model in response to applying the first classifier computing model to the first data stream, and
determine second performance data for the second classifier computing model in response to applying the second classifier computing model to the first data stream or the second data stream,
determine the third performance data based on the first performance data and the second performance data.
